(19) United States
(12) Patent Application Publication
(10) Pub. No.: US 2010/0129627 A1
(43) Pub. Date: May 27, 2010

(54) NON-WOVEN FIRE BARRIER MAT

(76) Inventors: Elam A. Leed, Pine, CO (US); Monroe Shumate, Centennial, CO (US); Susan M. Gee, Littleton, CO (US)

Correspondence Address: JOHNS MANVILLE, 10100 WEST UTE AVENUE, PO BOX 625005, LITTLETON, CO, 80162-5005, US

(21) Appl. No.: 12/277,179

(22) Filed: Nov. 24, 2008

(51) Int. Cl. B32B 5/02

(52) U.S. Cl. 428/219; 442/340

(57) ABSTRACT

A burnthrough resistant non-woven mat having an area weight of less than about 150 g/m², comprising inorganic fibers having an average fiber diameter of less than about four microns.

### BACKGROUND

The present disclosure relates to a burnthrough resistant non-woven mat, and in particular to a lightweight burnthrough resistant non-woven mat for use in thermal and acoustical insulation blankets used in commercial aircraft and in other applications requiring burn through properties of the type or similar to those properties currently required for commercial aircraft.

Commercial aircraft manufacturers and aircraft regulatory agencies in the United States have established combined thermal, acoustical, component and composite small scale flammability, fire barrier, fire propagation, smoke toxicity, moisture management, weight, fabricate-ability, health and cost requirements for insulation blankets. In particular, the Federal Aviation Administration (FAA) insulation burnthrough test is defined at www.fire.tc.faa.gov and by the test method to evaluate the burnthrough resistance characteristics of aircraft thermal/acoustic insulation materials when exposed to a high intensity open flame provided in §25.856 and 14 C.F.R. §25, Appendix F, Part VII and Advisory Circular 25.856-2A. The fire penetration resistance requirements of thermal/acoustic insulation used in transport category airplanes manufactured after Sep. 2, 2007, become effective Sep. 2, 2009.

U.S. Pat. No. 6,884,321 discloses a flame and heat resistant paper having high burnthrough prevention capability and prepared from modified aluminum oxide silica fibers, in addition to other components. While U.S. Pat. No. 6,884,321 discloses that the basis weight of the paper may range from about 5 to about 250 lb/3000 ft² (i.e., about 5 to about 250 pounds per ream), U.S. Pat. No. 6,884,321 also discloses that a paper as light as 5 pounds per ream may not pass burnthrough requirements, and that it may be advantageous to use multiple layers of a very thin lightweight paper, and that air space between such layers may prove desirable, for example, in the heat flux portion of the burnthrough test.

There remains a need for a lightweight aircraft blanket that responds to and meets all of the regulatory, aircraft manufacturer and aircraft operator requirements and expectations. The burnthrough resistant non-woven mat set forth in this patent application allows for assembly of such a lightweight blanket.

### SUMMARY

Provided is a burnthrough resistant non-woven mat having an area weight of less than about 150 g/m², comprising inorganic fibers having an average fiber diameter of less than about four microns.

Due to the fine diameter fibers of the presently disclosed non-woven mat, the presently disclosed mat can be lightweight and still achieve desired burnthrough resistance and low heat flux. Addition of coarse fibers to the presently disclosed non-woven mat improves tensile strength and durability in handling.

### DETAILED DESCRIPTION

It has been surprisingly discovered that a lightweight non-woven mat of fine diameter inorganic (e.g., high silica content) fibers can be made to possess good burnthrough resistance properties. As used herein, the phrase “fine diameter” means having an average fiber diameter of less than about four microns. Fine diameter fibers generally have an average fiber diameter of at least about 0.2 microns. In an embodiment, the fine diameter fibers have an average fiber diameter of less than about two microns. Fine diameter high silica content (i.e., comprising greater than about 93 weight %, for example, greater than about 95 weight % or greater than about 97 weight %, SiO₂) fibers can be formed by a leaching process with a sodium silicate glass precursor, for example. Fine diameter high silica content fibers possess good high temperature resistance due to high viscosity and corresponding high softening and melting temperatures.

An exemplary fine diameter high silica content fiber is Q-Fiber®, available from Johns Manville, Denver, Colo. Q-Fiber® is an amorphous, exceptionally pure fibrous silica material. Q-Fiber® is formed from high-silica-content sand which is melted, fiberized, acid-washed to remove impurities, rinsed, dried, and heat-treated for structural integrity. Q-Fiber® provides an excellent combination of physical properties including purity, resilience, light weight, as well as resistance to crystal formation, thermal shock, and heat flow. Extremely high in SiO₂ content (99.7 weight % after processing), chemically stable Q-Fiber® will not devitrify in response to elevated temperatures and rapid thermal cycling. Q-Fiber® Amorphous High-Purity Silica Fiber imparts high thermal efficiency with low weight. Q-Fiber® also resists thermal shock damage from drastic temperature fluctuations. Typical fiber diameter ranges from 0.75 to 1.59 microns but the process is amenable to a wider range of average fiber diameters. The chemical composition of Q-Fiber® can comprise ≧99.50 weight % (for example, ≧99.680 weight %) SiO₂, ≦0.20 weight % (for example, ≦0.130 weight %) R₂O₃ (wherein R is Al, Fe, and/or B), ≦0.10 weight % (for example, ≦0.013 weight %) TiO₂, ≦0.1 weight % (for example, ≦0.044 weight %) Fe₂O₃, ≦0.10 weight % (for example, ≦0.020 weight %) Na₂O, ≦0.10 weight % (for example, ≦0.005 weight %) K₂O, ≦0.10 weight % (for example, ≦0.032 weight %) CaO, ≦0.10 weight % (for example, ≦0.011 weight %) MgO, and ≦0.10 weight % (for example, ≦0.010 weight %) B.

In an embodiment, the fine diameter inorganic fiber is formed from a high-iron glass composition as disclosed in U.S. patent application Ser. Nos. 11/893,191 and 11/893,192, the contents of which are hereby incorporated by reference in their entireties. More specifically, the fine diameter inorganic fiber can comprise: (1) about 33-47 weight % SiO₂; about 18-28 weight % Al₂O₃; about 5-15 weight % Fe₂O₃; greater than or equal to about 2 weight % and less than 10 weight % R₂O; about 8-30 weight % CaO; and less than 4 weight % MgO; wherein R₂O represents alkali metal oxides; or (2) about 52-65 weight % SiO₂; less than or equal to 4 weight % Al₂O₃; about 7-16 weight % Fe₂O₃; greater than 6 weight % and less than or equal to about 14 weight % R₂O; about 6-25 weight % CaO; less than or equal to 10 weight % MgO; and about 10-25 weight % RO; wherein R₂O represents alkali metal oxides and RO represents alkaline earth metal oxides. In an embodiment, the fine diameter inorganic fiber are made from crystallizable glass comprising greater than about 5 weight % iron oxide.

In an embodiment, the presently disclosed burnthrough resistant non-woven mat comprises both fine diameter high silica content fiber (e.g., Q-Fiber®) and fine diameter inorganic fiber formed from a high-iron glass composition as disclosed in U.S. patent application Ser. Nos. 11/893,191 and 11/893,192.

As used herein, the phrase “burnthrough resistant” means that use of the presently disclosed non-woven mat as a fire barrier material in construction of an insulation blanket provides a test specimen that passes the FAA insulation burnthrough test. For example, an insulation blanket constructed with the presently disclosed non-woven mat as a fire barrier material and two layers of 1 inch thick 0.42 lb/ft³ fiberglass insulation material would pass the FAA insulation burnthrough test, while two layers of 1 inch thick 0.42 lb/ft³ fiberglass insulation material without the presently disclosed non-woven mat as a fire barrier material would fail the FAA insulation burnthrough test, for example, in about thirty seconds. According to 14 C.F.R. §25, Appendix F, Part VII, Subpart h, the FAA insulation burnthrough test requires that: (1) the insulation blanket test specimens must not allow fire or flame penetration in less than 4 minutes; and (2) the insulation blanket test specimens must not allow more than 2.0 Btu/ft²-sec (2.27 W/cm²) on the cold side of the insulation specimens at a point 12 inches (30.5 cm) from the face of the test rig. In an embodiment, the presently disclosed non-woven mat, if tested as the insulation blanket test specimen in the FAA insulation burnthrough test, would not allow fire or flame penetration in less than 4 minutes.

Thus, the presently disclosed burnthrough resistant non-woven mat can be used as a fire barrier material along with insulation material (e.g., low density fiberglass insulation material) in an insulation blanket meeting the FAA insulation burnthrough requirements that are effective Sep. 2, 2009. The insulation blanket assembly for use in aircraft typically consists of several layers of fiberglass insulation material of various densities loosely encapsulated in a polymer cover film. The presently disclosed burnthrough resistant non-woven mat can also be used as a loose insert or as a component of insulation cover film. Thus, the burnthrough resistant non-woven can be laminated to the outboard cover film, laminated to the outboard side of the insulation material, or inserted loosely between the insulation and the cover film on the outboard side.

An exemplary fiberglass insulation material to which the presently disclosed burnthrough resistant non-woven mat can be bonded is Microlite® AA, Microlite® AA Premium, and Microlite® AA Premium NR, available from Johns Manville, Denver, Colo. Microlite® AA Premium NR is a lightweight, flexible, thermal and acoustical insulation material designed to provide the ultimate in noise reduction at minimal weight. Microlite® AA Premium NR is formed from resin-bonded borosilicate biosoluble glass fibers. Microlite® AA Premium NR, bonded with a thermosetting phenolic resin, is noncombustible and meet industry and government standards for smoke density, smoke toxicity and total heat release. Microlite® AA Premium NR is furnished in densities of 0.34 lbs/ft³ (1 inch thick), 0.50 lbs/ft³ (1 inch thick), and 1.20 lbs/ft³ (⅜ inch thick). In an embodiment, the fiberglass insulation material has a density of about 0.29-1.20 lbs/ft³.

As the addition of coarse fibers aids in providing good non-woven mat integrity at low area weight, it has further been surprisingly discovered that the addition of coarse fibers can be used to create a burnthrough resistant non-woven mat with improved mechanical integrity (e.g., tensile strength). As used herein, the phrase “coarse fibers” means fibers having an average fiber diameter of greater than about six microns. Coarse fibers include, for example, chopped strand basalt-based glass fibers, high silica fibers formed by a leaching process similar to that of Q-Fiber®, and ceramic fibers such as 3M™ Nextel™. In an embodiment, the presently disclosed burnthrough resistant non-woven mat comprising coarse fibers has a tensile strength of at least about 3 lbs/in, for example, at least about 5 lbs/in.

Basalt chopped strand glass fibers can be melted from a variety of basalt rock types and formed into continuous fibers through a multi-orifice bushing, then fed to a chopper, for example. Basalt glass fibers possess high temperature resistance due to rapid crystallization when exposed to heat. The fibers having an average fiber diameter of greater than about six microns can also be made from crystallizable glass comprising greater than about 5 weight % iron oxide and/or comprise silica fibers comprising greater than about 93 weight %, for example, greater than about 95 weight %, silica.

Typically, the coarse fibers are formed by a continuous filament process and are larger than six microns. In contrast, the fine diameter fibers are formed by discontinuous wool fiber processes and could have average fiber diameters as high as six microns, though it would be unlikely that the fine wool fiber would be larger than four microns average diameter.

The combination of fine and coarse high temperature resistant fibers provides mechanical integrity, airflow resistance, and thermal dimensional stability that would not exist with individual components. The presently disclosed burnthrough resistant non-woven mat can be made with any number of different organic or inorganic binder systems to improve mechanical integrity at low and/or high temperatures.

A mat comprising fine diameter high silica content fibers, and optionally chopped strand basalt fibers, has much better flexibility and is less brittle than ceramic fiber papers. The presently disclosed burnthrough resistant non-woven mat has an area weight of less than about 150 g/m², for example, less than about 120 g/m², less than about 100 g/m², less than about 70 g/m², or about 40-60 g/m². In an embodiment, the presently disclosed burnthrough resistant non-woven mat, used as a fire barrier material, is laminated to fiberglass insulation material (or laminated to the insulation cover film) and has an area weight of about 40-60 g/m².

The presently disclosed burnthrough resistant non-woven mat can be designed through selection of organic and/or inorganic binders to meet the flammability and flame propagation requirements of components used in aircraft thermal and acoustical insulation. Details of the flammability and flame propagation requirements can be found in §25.856 and 14 C.F.R. §25, Appendix F, Part VII and Advisory Circular 25.856-2A.

In an embodiment, an opacifier such as silicon carbide, titania, kaolin clay, or SiO₂ fume can be added to the mat to reduce the heat penetration into and through the mat. The opacifier content can range, for example, up to about 15 weight % of the non-woven mat.

The following examples are intended to be exemplary and non-limiting.

### Examples

Table 1 shows non-woven mat fiber compositions tested using a lab scale mimic of the FAA insulation burnthrough test. The mimic of the FAA insulation burnthrough test uses a flame with slightly higher temperature than the FAA insulation burnthrough test and is carried out for a longer duration than the FAA insulation burnthrough test. In particular, parameters of the mimic of the FAA insulation burnthrough test include sample size of 12″×12″, two 1″ layers of 0.42 lb/ft³ fiberglass insulation behind the burnthrough non-woven, temperatures of 2000° F.±100° F., burner cone of 2.5″ in diameter, and required time for passing of 10 minutes.

The Q-Fiber® used in the Samples A through J was comprised of 99.7 weight % SiO₂, and had an average fiber diameter of 0.5 to 2 microns. The high-iron content fiber used in Samples J and K was comprised of 39.1 weight % SiO₂; 23.4 weight % Al₂O₃; 8.6 weight % Fe₂O₃; 0.5 weight % TiO₂; 4.8 weight % Na₂O; 4.2 weight % K₂O; 9.0 weight % R₂O; 17.7 weight % CaO; 1.6 weight % MgO; and 19.3 weight % RO; wherein R₂O represents alkali metal oxides and RO represents alkaline earth metal oxides, and had an average fiber diameter of 0.8 to 1.2 microns. The basalt fiber used in the Samples E through K had an average fiber diameter of 13 microns.

TABLE 1

| | Sample | | | | | | | | | | |
|---|---|---|---|---|---|---|---|---|---|---|---|
| | A | B | C | D | E | F | G | H | I | J | K |
| Q-fiber ® | 120 | 67 | 95 | 58 | 55 | 23 | 20 | 15 | 25 | 37 | 0 |
| (g/m²) | | | | | | | | | | | |
| Basalt Fiber | 0 | 0 | 0 | 0 | 55 | 47 | 20 | 40 | 24 | 37 | 55 |
| (g/m²) | | | | | | | | | | | |
| High-Iron | 0 | 0 | 0 | 0 | 0 | 0 | 0 | 0 | 0 | 37 | 55 |
| Content Fiber | | | | | | | | | | | |
| (g/m²) | | | | | | | | | | | |
| Total Fiber | 120 | 67 | 95 | 58 | 110 | 70 | 40 | 55 | 49 | 111 | 110 |
| (g/m²) | | | | | | | | | | | |
| Tensile | | | 2.6 | 1.2 | | 7.1 | 3.5 | | | 8.9 | |
| Strength | | | | | | | | | | | |
| (lbs/in) | | | | | | | | | | | |
| Mimic | Pass | Pass | Pass | Pass | Pass | Pass | Pass | Pass | Pass | Pass | Pass |
| Burnthrough | | | | | | | | | | | |
| Test | | | | | | | | | | | |

Additionally, sample I was tested as a cover film at the FAA laboratory and passed the FAA insulation burnthrough test. In particular, the non-woven burnthrough barrier was laminated to the outboard (flame side) cover film and the insulation consisted of two 1″ layers of 0.42 lb/ft³ fiberglass insulation.

Samples C and D, comprised solely of Q-Fiber® and having no coarse basalt fiber exhibited tensile strengths of 2.6 lbs/in and 1.2 lbs/in, respectively. In particular, Sample C was comprised of 95 g/m² of Q-Fiber®, while Sample D was comprised of 58 g/m² of Q-Fiber®. In contrast, Samples F and G, comprised of Q-Fiber® and coarse basalt fiber exhibited tensile strengths of 7.1 lbs/in and 3.5 lbs/in, respectively. In particular, Sample F was comprised of 23 g/m² of Q-Fiber® and 47 g/m² of coarse basalt fiber (70 g/m² of total fiber), while Sample G was comprised of 20 g/m² of Q-Fiber® and 20 g/m² of coarse basalt fiber (40 g/m² of total fiber). Thus, the samples with basalt have higher tensile strength at lower total weight. Further, Sample J, comprised of 37 g/m² of Q-Fiber®, 37 g/m² of coarse basalt fiber, and 37 g/m² of high-iron content fiber (111 g/m² of total fiber), exhibited a tensile strength of 8.9 lbs/in.

While various embodiments have been described, it is to be understood that variations and modifications may be resorted to as will be apparent to those skilled in the art. Such variations and modifications are to be considered within the purview and scope of the claims appended hereto.

What is claimed is:

1. A burnthrough resistant non-woven mat:
having an area weight of less than about 150 g/m²; and
comprising inorganic fibers having an average fiber diameter of less than about four microns.

2. The burnthrough resistant non-woven mat of claim 1, wherein the inorganic fibers having an average fiber diameter of less than about four microns comprise silica.

3. The burnthrough resistant non-woven mat of claim 2, wherein the inorganic fibers having an average fiber diameter of less than about four microns comprise greater than about 93 weight % SiO₂.

4. The burnthrough resistant non-woven mat of claim 3, wherein the inorganic fibers having an average fiber diameter of less than about four microns comprise ≧99.50 weight % SiO₂, ≦0.20 weight % R₂O₃ wherein R is Al, Fe, and/or B, ≦0.01 weight % TiO₂, ≦0.1 weight % Fe₂O₃, ≦0.10 weight % Na₂O, ≦0.10 weight % K₂O, ≦0.10 weight % CaO, ≦0.10 weight % MgO, and ≦0.10 weight % B.

5. The burnthrough resistant non-woven mat of claim 1, wherein the inorganic fibers having an average fiber diameter of less than about four microns comprise inorganic fibers having an average fiber diameter of less than about two microns.

6. The burnthrough resistant non-woven mat of claim 1, wherein the inorganic fibers having an average fiber diameter of less than about four microns are made from crystallizable glass comprising greater than about 5 weight % iron oxide.

7. The burnthrough resistant non-woven mat of claim 1, wherein the mat has an area weight less than about 100 g/m².

8. The burnthrough resistant non-woven mat of claim 1, wherein the mat has an area weight less than about 70 g/m².

9. The burnthrough resistant non-woven mat of claim 1, further comprising inorganic fibers having an average fiber diameter of greater than about six microns.

10. The burnthrough resistant non-woven mat of claim 9, wherein the inorganic fibers having an average fiber diameter of greater than about six microns are made from crystallizable glass comprising greater than about 5 weight % iron oxide.

11. The burnthrough resistant non-woven mat of claim 9, wherein the inorganic fibers having an average fiber diameter of greater than about six microns are made from basalt.

12. The burnthrough resistant non-woven mat of claim 9, wherein the inorganic fibers having an average fiber diameter of greater than about six microns comprise silica fibers comprising greater than about 93 weight % silica.

13. The burnthrough resistant non-woven mat of claim 1, further comprising binder.

14. The burnthrough resistant non-woven mat of claim 1, further comprising opacifier.

15. The burnthrough resistant non-woven mat of claim 14, wherein the opacifier is selected from the group consisting of silicon carbide, titania, kaolin clay, SiO₂ fume, and mixtures thereof.

16. An insulation blanket comprising the burnthrough resistant non-woven mat of claim 1 laminated to fiberglass insulation material.

17. An insulation blanket comprising the burnthrough resistant non-woven mat of claim 1 laminated to an insulation cover film.

18. The insulation blanket of claim 16, wherein the fiberglass insulation material has a density of about 0.29-1.20 lbs/ft³.

19. The burnthrough resistant non-woven mat of claim 1, wherein the mat consists of inorganic fibers having an average fiber diameter of less than about four microns.

20. The burnthrough resistant non-woven mat of claim 9, wherein the mat has a tensile strength of at least about 3 lbs/in.
